(19) United States
(12) Patent Application Publication
(10) Pub. No.: US 2016/0132855 A1
(43) Pub. Date: May 12, 2016

(54) COMMODITY SALES DATA PROCESSING APPARATUS, READING APPARATUS AND METHOD BY THE SAME

(71) Applicant: TOSHIBA TEC KABUSHIKI KAISHA, Tokyo (JP)

(72) Inventor: Kosuke Yamamoto, Izunokuni (JP)

(21) Appl. No.: 14/930,698

(22) Filed: Nov. 3, 2015

(30) Foreign Application Priority Data
Nov. 6, 2014 (JP) 2014-226137

(51) Int. Cl. G06Q 20/20; G06K 9/00; G07G 1/00; G06Q 30/06

(52) U.S. Cl. CPC G06Q 20/208; G06Q 30/06; G06K 9/00577; G07G 1/0045

(57) ABSTRACT

A commodity sales data processing apparatus comprises an image capturing module which photographs a commodity and output the appearance image of the commodity; an extraction module which extracts barcode information from the appearance image of the commodity output from the image capturing module; an object recognition module which performs an object recognition processing on the appearance image of the commodity output from the image capturing module; an exclusion module which excludes, if barcode information is extracted from the appearance image of the commodity by the extraction module, the appearance image of the commodity from targets of the object recognition processing by the object recognition module; a determination module which determines the commodity to be sales-registered according to the result of the object recognition processing; and a sales registration module which carries out a sales registration of the commodity determined by the determination module.

### CROSS-REFERENCE TO RELATED APPLICATION

This application is based upon and claims the benefit of priority from Japanese Patent Application No. 2014-226137, filed Nov. 6, 2014, the entire contents of which are incorporated herein by reference.

### FIELD

Embodiments described herein relate to a commodity sales data processing apparatus, a reading apparatus and a method by the same.

### BACKGROUND

Conventionally, to recognize a purchased commodity, an object recognition scanner is used in a POS (Point-of-Sale) system. The object recognition scanner acquires information indicating the appearance of a purchased commodity using an imaging sensor module such as a CCD (Charge Coupled Device), executes an image processing for the information and determines, through automatic determination or the selection of the user, which commodity corresponds to the purchased commodity. The determination of the purchased commodity is carried out based on the comparison of feature amounts of commodity images. The object recognition scanner generates the feature amount of the purchased commodity through the image processing and calculates the similarity degree between the feature amount of the purchased commodity and the feature amount of each of commodities contained in dictionary data. In a case where which commodity corresponds to the purchased commodity is determined automatically, a commodity having high similarity degree to the purchased commodity among all the commodities is determined as the purchased commodity. Further, in a case where which commodity corresponds to the purchased commodity is designated by the user, the commodities having high similarity degree to the purchased commodity are displayed on a screen as commodity candidates for the user to select a commodity candidate to determine the selected commodity candidate as the purchased commodity.

### DESCRIPTION OF THE DRAWINGS

FIG. 1 is a concept diagram illustrating the structure of a self-checkout POS terminal;

FIG. 2 is a perspective view exemplifying the self-checkout POS terminal;

FIG. 3 is a block diagram illustrating the hardware structure of the self-checkout POS terminal;

FIG. 4 is a block diagram illustrating the functional structure of the self-checkout POS terminal;

FIG. 5 is a flowchart exemplifying a series of operations carried out by the self-checkout POS terminal to read a commodity;

FIG. 6 is a flowchart exemplifying the operations carried out by a commodity reading section;

FIG. 7 is a block diagram illustrating the functional structure of a self-checkout POS terminal according to a modification 1;

FIG. 8 is a flowchart exemplifying a series of operations carried out by the self-checkout POS terminal to read a commodity; and

FIG. 9 is a flowchart exemplifying the operations carried out by a commodity reading section.

### DETAILED DESCRIPTION

In accordance with embodiments of the present invention, a commodity sales data processing apparatus comprises an image capturing module configured to photograph a commodity and output the appearance image of the commodity; an extraction module configured to extract barcode information from the appearance image of the commodity output through the image capturing module; an object recognition module configured to perform an object recognition processing on the appearance image of the commodity output through the image capturing module; an exclusion module configured to exclude, if barcode information is extracted from the appearance image of the commodity by the extraction module, the appearance image of the commodity from the targets on which the object recognition processing is to be performed by the object recognition module; a determination module configured to determine the commodity to be sales-registered according to the result of the object recognition processing; and a sales registration module configured to carry out sales registration of the commodity determined by the determination module.

Embodiments of a commodity sales data processing apparatus, a reading apparatus and a method are described below in detail with reference to accompanying drawings.

It is exemplified in the present embodiments that the application of the commodity sales data processing apparatus to a self-checkout POS terminal which comprises a commodity registration section configured to register a commodity through object recognition and a settlement processing section configured to carry out a settlement processing for the commodity registered by the commodity registration section.

The commodity registration section acquires the appearance information (e.g. contour shape•tint•pattern•concave-convex state) of a commodity photographed by an image capturing section such as a color COD (Charge Coupled Device) or a color CMOS (Complementary MOS) as an image and performs an object recognition processing on the image (appearance image). The object recognition processing which will be described in detail later is a commodity candidate presentation processing consisting of extracting data for collation (feature amount) from the appearance image of the commodity and comparing the data for collation with the feature amount of each of commodities registered in dictionary data.

The commodity registration section determines, automatically or according to the designation of the user, the one of the commodity candidates obtained from the object recognition which corresponds to the commodity and registers the determined commodity as a sales commodity. Further, the settlement processing section carries out a settlement processing for the commodity registered by the commodity registration section.

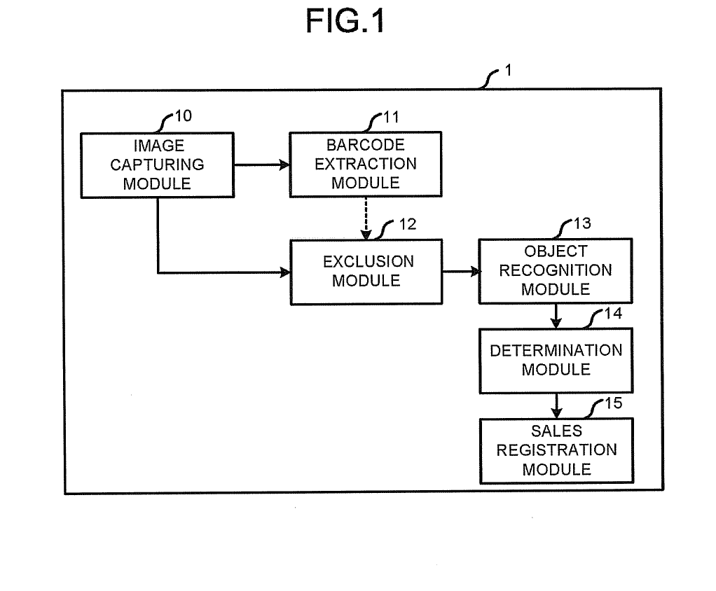

FIG. 1 is a concept diagram illustrating the structure of a self-checkout POS terminal 1 for carrying out the object recognition of a commodity attached with a barcode. In FIG. 1, the solid arrow indicates the flow of data, and the dotted arrow indicates a control.

As shown in FIG. 1, the self-checkout POS terminal 1 comprises an image capturing module 10, a barcode extraction module (extraction module) 11, an exclusion module 12, an object recognition module 13, a determination module 14 and a sales registration module 15.

The image capturing module 10 photographs a commodity using the image capturing section and outputs an image containing the commodity and a background.

The barcode extraction module 11 extracts barcode information from the image output from the image capturing module 10. The barcode information is extracted by searching for a contour such as a seal printed with a barcode or the bars and spaces constituting a barcode through pattern matching. In the present embodiments, if the contours of bars and spaces are searched, a figure composed of the bars and spaces is decoded to generate barcode information.

As long as the barcode information is extracted by the barcode extraction module 11 from the image, the exclusion module 12 excludes an image containing barcode information from the targets on which an object recognition processing is to be performed. The extraction module 12 detects the generation of barcode information according to an image through a control signal from the barcode extraction module 11. Moreover, the exclusion module 12 erases the image output from the image capturing module 10 before the image is transferred to the object recognition module 13 (that is, the image is not input to the object recognition module 13), thereby excluding the image from the targets on which an object recognition processing is to be performed. Alternatively, the exclusion module 12 notifies the object recognition module 13 that no object recognition processing is to be executed, thereby excluding the image transferred to (input into) the object recognition module 13 from the targets on which an object recognition processing is to be performed.

The object recognition module 13 performs an object recognition processing (pre-processing) on the image output from the image capturing module 10. In the object recognition processing (pre-processing), a commodity area is specified according to the image, and information indicating the tendency such as the tint, the pattern and the concave-convex state of the commodity included in the area is calculated as a feature amount.

In an object recognition processing (post-processing), the determination module 14 determines the commodity according to the feature amount generated by the object recognition processing (pre-processing). The determination module 14 compares the feature amount generated by the object recognition processing (pre-processing) with the feature amount of each of the commodities contained in the dictionary data to obtain a similarity degree to determine the commodities contained in the dictionary data which have high similarity degree as commodity candidates of the commodity. Moreover, the determination module 14 determines one of the commodity candidates as the commodity. For example, the cashier selects one of the commodity candidates displayed on the screen as the commodity. Alternatively, according to the result of the comparison of the feature amount of the commodity with that of each of commodities contained in the dictionary data, a commodity among the commodity candidates the similarity degree of which with the commodity is higher than a specific value and which has the highest similarity degree is automatically determined as the commodity.

The sales registration module 15 carries out the sales registration of the commodity. The sales registration module 15 registers the commodity determined by the determination module 14 in a sales master file as a sales commodity.

Sequentially, the whole structures of the self-checkout POS terminal are described.

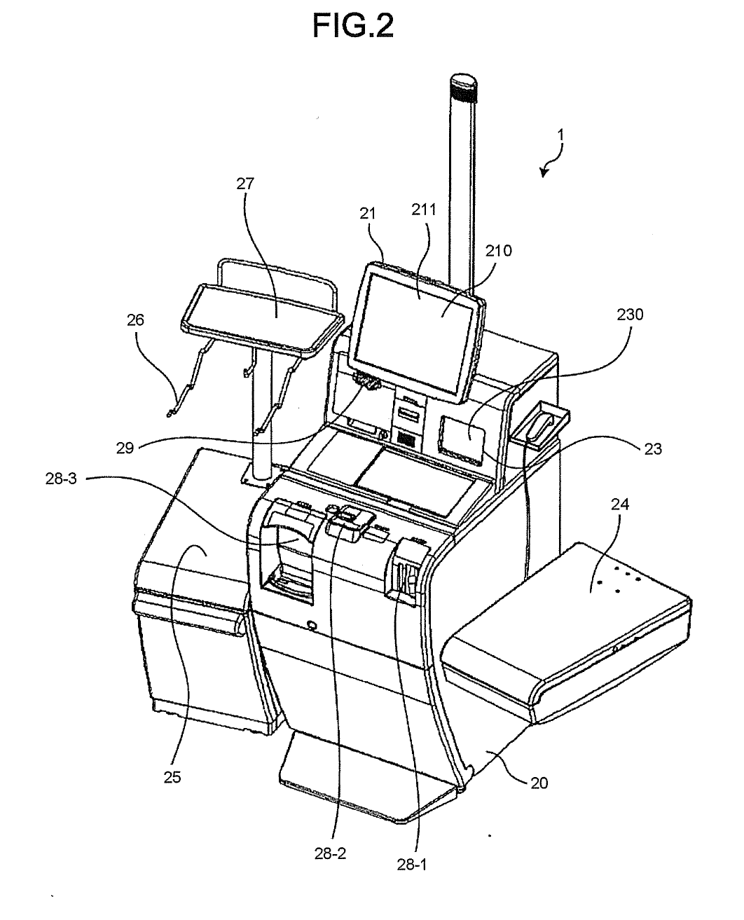

FIG. 2 is a perspective view exemplifying the self-checkout POS terminal 1.

The self-checkout POS terminal 1 is arranged in a store such as a supermarket to be used. The main body 20 of the self-checkout POS terminal 1 comprises a touch input-type display 21 and a commodity reading section 23 for reading the image of a commodity.

The touch input-type display 21 comprises a touch panel 210 and a display device 211. The display device 211 is, for example, a liquid crystal display. The touch panel 210 is overlapped on the display screen. The display device 211 displays a guidance screen for guiding the user to operate the self-checkout POS terminal 1 and various input keys for the user to operate. The guidance screen includes a commodity selection screen on which commodity candidates of the commodity read by the commodity reading section 23 are indicated by illustration images and a settlement screen on which the total amount, the deposit amount and the change amount of the commodities subjected to sales registration and payment method options are displayed.

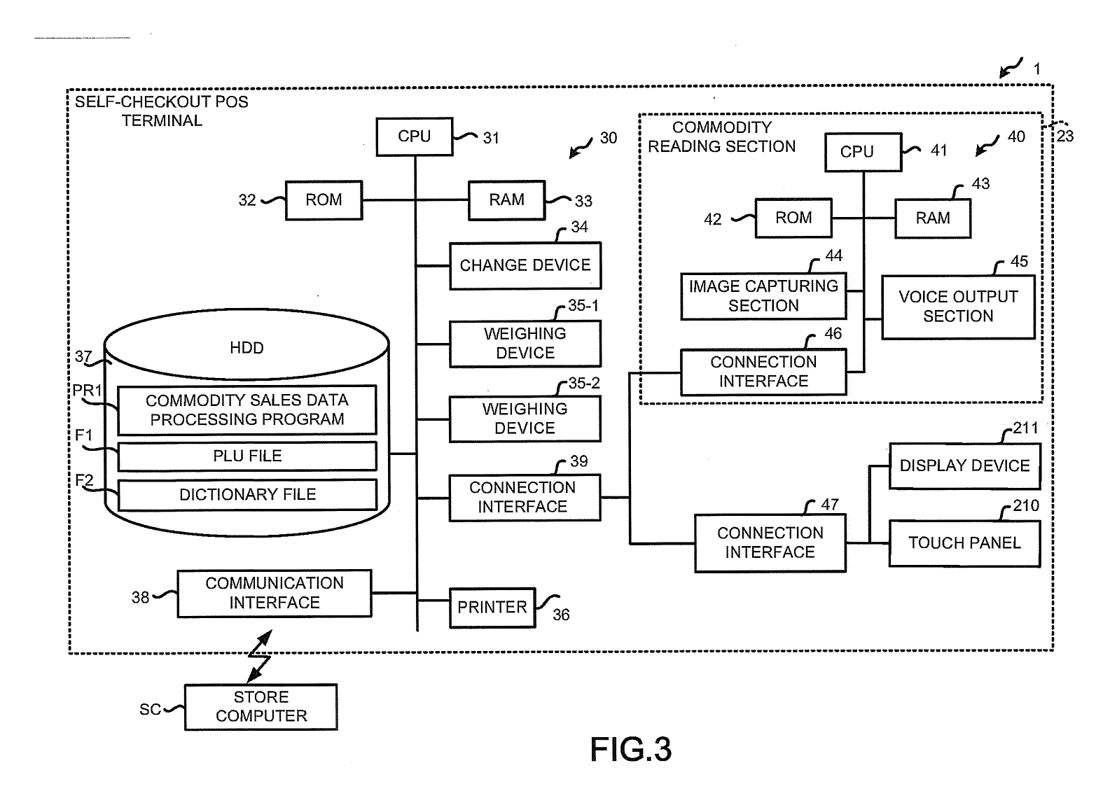

The commodity reading section 23 is equipped with an image capturing section 44 (refer to FIG. 3) arranged at the rear side of the reading window 230. The commodity reading section 23 photographs a commodity using the image capturing section 44 when the customer holds the barcode attached to the commodity over the reading window 230 of the commodity reading section 23, thereby forming the image of the commodity. The commodity reading section 23 is a reading apparatus (unit) which is electrically connected with the main body via a connection interface 46 (refer to FIG. 3) and which can be detached from the main body 20 (including an object recognition processing device). Further, the commodity reading section 23 may be integrated with the main body 20.

A commodity placing table 24 for holding an unsettled commodity placed in a basket is arranged at the right side of the main body 20. A commodity placing table 25 for holding a settled commodity is arranged at the left side of the main body 20. A bag hook 26 for hooking a bag in which settled commodities are placed and a temporary placing table 27 for temporarily holding a settled but not bagged commodity are arranged on the commodity placing table 25. Weighing devices 35-1 and 35-2 (refer to FIG. 3) are respectively arranged on the commodity placing tables 24 and 25 to confirm whether or not the weight of a commodity is changed after the commodity is settled.

Further, a bill depositing and dispensing port 28-1 through which bill is input for settlement and bill is output as change, a coin depositing port 28-2 through which coins are input for settlement and a coin dispensing port 28-3 through which coins are output as change are arranged on the main body 20 of the self-checkout POS terminal 1. Further, a receipt issuing port 29 for issuing a receipt is arranged on the main body 20.

The shopping basket (not shown) carried by the customer is placed on the commodity placing table 24. The commodities in the shopping basket are one by one moved by the customer into an empty shopping basket (not shown) placed on the commodity placing table 25 for settlement. During the movement process, if the customer holds the commodity over the reading window 230 of the commodity reading section, then the image capturing section 44 (refer to FIG. 3) arranged inside the reading window 230 photographs the commodity.

FIG. 3 is a block diagram illustrating the hardware structure of the self-checkout POS terminal 1. The self-checkout POS terminal 1 comprises a micro computer 30 functioning as an information processing section for carrying out an information processing. The micro computer 30 is formed by connecting, via a bus line, a ROM (Read Only Memory) 32 and a RAM (Random Access Memory) 33 with a CPU (Central Processing Unit) 31 that carries out various operations to control each section. When reading a commodity, the micro computer 30 mainly operates as an object recognition processing section relating to an object recognition processing.

The CPU 31 is connected with a change device 34 provided with the bill depositing and dispensing port 28-1, the coin depositing port 28-2 and the coin dispensing port 28-3 and the weighing devices 35-1 and 35-2 for weighing the commodities in the shopping baskets placed on the commodity placing tables 24 and 25. Further, the CPU 31 is connected with a printer 36 equipped with the receipt issuing port 29. These devices are controlled by the CPU 31.

The CPU 31 is connected with an HDD (Hard Disk Drive) 37 in which programs and various files are stored. The programs and various files stored in the HDD 37 are all or partially copied into the RAM 33 to be executed by the CPU 31 when the self-checkout POS terminal 1 is activated. An example of the programs stored in the HDD 37 is a commodity sales data processing program PR1. An example of the files stored in the HDD 37 is a PLU file F1 or a dictionary file F2 sent from a store computer SC and then stored in the HDD 37. A sales master file (not shown) is stored in the HDD 37. Besides, if the HDD 37 is a storage device, then the HDD 37 may consist of another storage medium such as a SSD (Solid State Drive) and the like.

The PLU file F1 is a commodity file which stores the information relating to the sales registration of each commodity displayed in a store for sale. The dictionary file F2 stores the feature amounts of a plurality of commodities as data for collation. If a feature amount of a photographed commodity is calculated, then the CPU 31 collates the feature amount of the photographed commodity with the feature amount of each of commodities stored in the dictionary file F2. Moreover, the similarity degree between the feature amount of the photographed commodity and that of each of the commodities stored in the dictionary file F2 is calculated.

The PLU file F1 stores the information relating to each commodity and commodity ID of the commodity. The dictionary file F2 stores the illustration image and the feature amount of each commodity. The commodity ID is identification information capable of identifying a commodity. The information relating to a commodity refers to a commodity category, a commodity name, variety and unit price to which a commodity A belongs. The illustration image is an image indicating the commodity.

The CPU 31 is connected with a communication interface 38 for executing the data communication with the store computer SC. The store computer SC is arranged in the back office of the store. The PLU file F1 to be sent to the self-checkout POS terminal 1 is stored in the HDD (not shown) of the store computer SC.

The CPU 31 of the self-checkout POS terminal 1 is further connected with a connection interface 39 which is capable of transmitting/receiving data to/from the commodity reading section (unit) 23 and the touch input-type display 21. The connection interface 39 is connected with the commodity reading section 23 and the touch input-type display 21.

The touch input-type display 21 comprises a touch panel 210, a display device 211 and a connection interface 47.

The commodity reading section 23 comprises a micro computer 40 which is formed by connecting a ROM 42 and a RAM 43 with a CPU 41 via a bus line. The micro computer 40 mainly operates as a processing section for photographing a commodity and for the pre-processing of object recognition. The programs (e.g. an exclusion program Pro 2) executed by the CPU 41 are stored in the ROM 42. The CPU 41 is connected with the image capturing section 44 and a voice output section 45. The CPU 41 controls the operations of the image capturing section 44 and the voice output section 45.

The image capturing section 44 is equipped with an image sensor (not shown) such as a color CCD image sensor or a color CMOS image sensor and a light source (not shown) such as an LED. The image capturing section 44 photographs a commodity from the inside of the reading window 230 at a given frame rate under the control of the CPU 41. For example, the image capturing section 44 captures an image of the commodity at 30 fps (Frame Per Second). The frame images (captured images) sequentially captured by the image capturing section 44 at the given frame rate are sequentially stored in the RAM 43.

The voice output section 45 is a voice circuit or a loudspeaker for generating preset voice or warning voice. The voice output section 45 gives a voice notice or a warning voice notice under the control of the CPU 41.

The CPU 41 is further connected with a connection interface 46 which is capable of transmitting/receiving data to/from the CPU 31. The connection interface 39 of the main body 20 is connected with the connection interface 46.

Sequentially, the functional structure of the self-checkout POS terminal 1 is described.

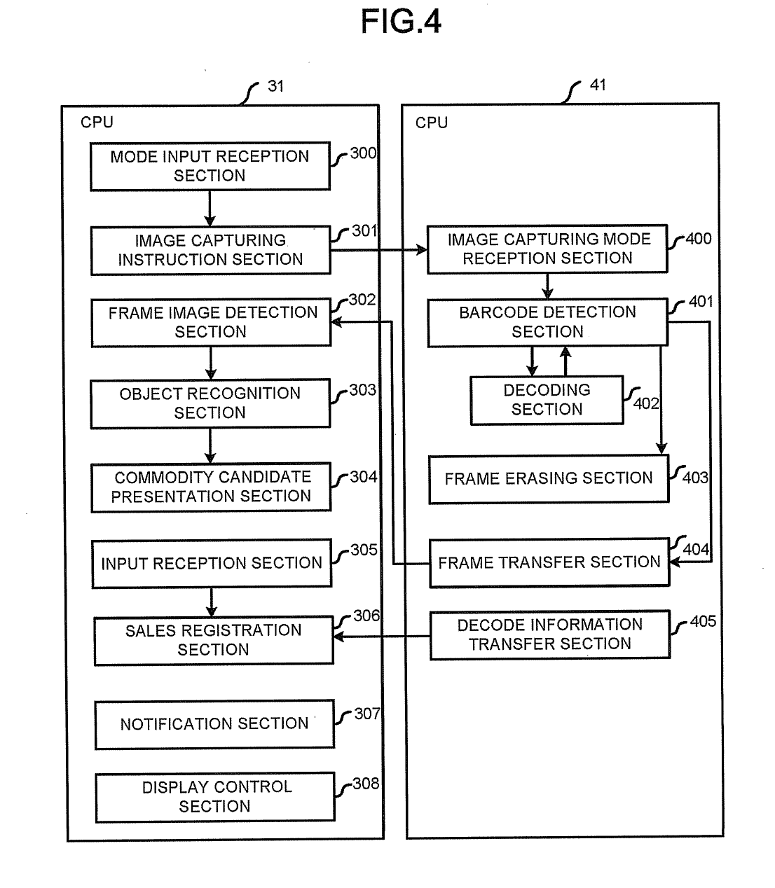

FIG. 4 is a block diagram illustrating the functional structure of the self-checkout POS terminal 1. The solid arrow shown in FIG. 4 indicates an instruction direction.

The functions of the CPU 31 are described first.

The CPU 31 functions as a mode input reception section 300, an image capturing instruction section 301, a frame image detection section 302, an object recognition section 303 and a commodity candidate presentation section 304. The CPU 31 further functions as an input reception section 305, a sales registration section 306, a notification section 307 and a display control section 308.

These functions are realized through the execution of programs (the commodity sales data processing program PR1) by the CPU 31.

The mode input reception section 300, which is a mode indicating a commodity recognition processing, receives a designation input of either of an object recognition mode and a barcode recognition mode. The mode input reception section 300 provides, on the screen of the display device 211, selection keys of various modes to urge the user to designate a mode by pressing a selection key. Moreover, the mode input reception section 300 receives the mode corresponding to the key pressed by the user as the mode of the commodity recognition processing.

The image capturing instruction section 301 instructs the commodity reading section 23 to start an image capturing processing in the mode received by the mode input reception section 300. Specifically, the image capturing instruction section 301 outputs mode information of the mode received by the mode input reception section 300 and an image capturing start command to the commodity reading section 23.

The frame image detection section 302 detects that the frame images of a commodity are transferred from the commodity reading section 23 to be stored in the RAM 33 after the frame images of the commodity are captured.

The object recognition section 303 performs an object recognition processing (pre-processing) on the frame image detected by the frame image detection section 302. The object recognition processing (pre-processing) is a processing of, for example, determining a commodity image area in a frame image and extracting the appearance information such as the tint, the pattern and the concave-convex state of surface of the commodity shown in the area as a feature amount.

The commodity candidate presentation section 304 presents, according to the feature amount of the commodity extracted by the object recognition section 303, commodity candidates of the commodity for the customer to execute an object recognition processing (post-processing). Herein, the commodity candidate presentation section 304 compares the feature amount of the commodity with the feature amount of each of commodities stored in the dictionary file F2 to calculate a similarity degree. Moreover, the illustration image of a commodity having a higher similarity degree is preferably displayed on a display screen as a commodity candidate. In this way, the commodity candidate of the commodity is presented to the customer.

Herein, the similarity degree represents, numerically, how much similar each commodity registered in the dictionary file F2 is to the commodity. The higher the value of the similarity degree is, the more similar a commodity registered in the dictionary file F2 is to the commodity.

As an example, the similarity degree between the commodity and each commodity registered in the dictionary file F2 is calculated using an absolute evaluation method or a relative evaluation method.

In a case where the similarity degree between the commodity and each commodity registered in the dictionary file F2 is calculated using an absolute evaluation method, the commodity candidate presentation section 304 compares the feature amount of the commodity with the feature amount of each of commodities stored in the dictionary file F2 one to one to derive a similarity degree and adopts the derived similarity degree as it is. On the other hand, in a case where the similarity degree between the commodity and each commodity registered in the dictionary file F2 is calculated using a relative evaluation method, the commodity candidate presentation section 304 calculates the similarity degree of each commodity so that the sum of the similarity degrees of the commodity and the commodities registered in the dictionary file F2 is 1.0 (100%).

According to the result of the calculation of the similarity degree of each commodity, the commodities registered in the dictionary file F2 the similarity degree of which is higher than a given threshold value are determined as commodity candidates.

The object recognition usually used in the foregoing object recognition processing is called generic object recognition. Recognition technologies for generic object recognition are illustrated in the following document:

Keiji Yanai ‘The current state and future directions of generic object recognition’, Journal of Information Processing Society, Vol. 48, No. SIG 16 [Search on Heisei August 10], Internet <URL:http://mm.cs.uec.ac.jp/IPSJ-TCVIM-Yanai.pdf>

In addition, the technology for carrying out the generic object recognition through performing an area-division on the image for each object is described in the following document:

Jamie Shotton: “Semantic Texton Forests for Image Categorization and Segmentation”, [Search on Heisei 22 August 10], Internet <URL:http://citeseerx.ist.psu.edu/viewdoc/download?doi=10.1.1.145.3036&rep=rep1&type=pdf>

The input reception section 305 receives an input from an input key displayed on the display screen. Moreover, processing is classified according to the input. Herein, specifically, the input reception section 305 receives an input for determining a commodity from the commodity candidates presented by the commodity candidate presentation section 304. For example, the customer presses a commodity from the plurality of commodity candidates (illustration image key) displayed on the display screen. The input reception section 305 receives the press signal to determine the commodity candidate corresponding to the illustration image key pressed by the customer as the commodity.

The sales registration section 306 sales-registers the commodity determined through an object recognition processing or a barcode recognition processing. If the commodity is determined through an object recognition processing, the sales registration section 306 sales-registers the commodity received by the input reception section 305. In a case where the commodity is determined through the other barcode recognition processing, the sales registration section 306 sales-registers the commodity indicated by the information obtained by decoding the barcode in the commodity reading section 23. Further, if the commodity is determined, then the sales registration section 306 of the present example refers to the data stored in the PLU file F1. Moreover, the commodity data of the determined commodity, such as the category, the name and the price of the commodity, is acquired from the PLU file F1. Further, the acquired data is recorded in the sales master file to carry out the sales registration of the commodity.

The notification section 307 notifies the sales registration of the commodity when the sales registration section 306 sales-registers the commodity. The notification section 307 notifies the sales registration of the commodity by generating a buzzer sound from the voice output section or displaying a notification screen on the display device 211.

The display control section 308 controls the display such as an operation screen, an error screen and a commodity candidate list screen on the display device 211.

Next, the functions of the CPU 41 of the commodity reading section 23 are described.

The CPU 41 functions as an image capturing mode reception section 400, a barcode detection section 401, a decoding section 402, a frame erasing section 403, a frame transfer section 404 and a decode information transfer section 405.

These functions are realized through the execution of programs (e.g. the exclusion program Pro 2) by the CPU 41.

The image capturing mode reception section 400 receives mode information of the commodity recognition processing from the image capturing instruction section 301. Then, the image capturing mode reception section 400 outputs an image capturing ‘ON’ signal to the image capturing section 44 to start to photograph a commodity.

The barcode detection section 401 carries out a pattern matching processing for barcodes aiming at the frame images stored in the RAM 43 after the image capturing processing is started to detect a barcode part in the frame image. The barcode detection section 401, for example, carries out the pattern matching processing aiming at the frame images according to the contour shape of a seal printed with a barcode. If an image having the same contour shape with the seal is detected (temporarily extracted) in a frame image, then the inclusion of a barcode part in the frame image is temporarily determined. Besides, the barcode detection section 401 carries out the pattern matching processing according to contour shapes of the bars and the spaces consisting of a barcode. If images having the same contour shapes with the bars and the spaces are detected (temporarily extracted) in a frame image, then the inclusion of a barcode part in the frame image is temporarily determined.

The decoding section 402 functions when the barcode detection section 401 detects a barcode part. The decoding section 402 decodes barcode information of the barcode part included in a frame image. If the barcode of the barcode part is decoded, the decoding section 402 checks whether or not the decoded barcode information (decode information) is information corresponding to a code for identifying the commodity. Moreover, if the decode information is the information corresponding to the code for identifying the commodity, then it can be finally determined that the frame image includes a barcode part. The check on whether or not the decode information corresponds to the code for identifying the commodity is carried out according to the values taken by the numerals included in the code or the number of digits of the code.

The frame erasing section 403 is the function of the object recognition mode. If it is finally determined that the frame image includes a barcode part, the frame erasing section 403 erases the frame image from the RAM 43. In the object recognition mode, the frame erasing section 403 erases the frame image including a barcode part so as to exclude the processing of the frame image including a barcode part from the recognition processing of the frame images carried out the object recognition section 303.

The frame transfer section 404 is also the function of the object recognition mode. If the decoding section 402 determines that a frame image includes no barcode part, the frame transfer section 404 notifies the CPU 31 to transfer the frame image from the RAM 43 to the RAM 33.

The decode information transfer section 405 is the function of the barcode recognition mode. If decode information is generated by the decoding section 402, then the decode information transfer section 405 notifies the CPU 31 of the generated decode information and transfers the processing of the decode information to the sales registration section 306.

In the present example, after the barcode detection section 401 temporarily determines that a barcode part is included in the frame image, whether or not the frame image includes a barcode part is finally determined based on the decoding processing of the decoding section 402. However, the self-checkout POS terminal 1 of the embodiments is not limited to determine the inclusion of a barcode part in a frame image in this way. It is applicable that the existence of a barcode image in a frame image can be finally determined after the barcode detection section 401 temporarily determines that the barcode image is included in the frame image.

Sequentially, the operations of the self-checkout POS terminal 1 are described.

If the customer instructs the self-checkout POS terminal 1 to start a registration and settlement processing in accordance with the guidance screen of the self-checkout POS terminal 1, then the self-checkout POS terminal 1 starts to read a commodity registered through a commodity registration processing.

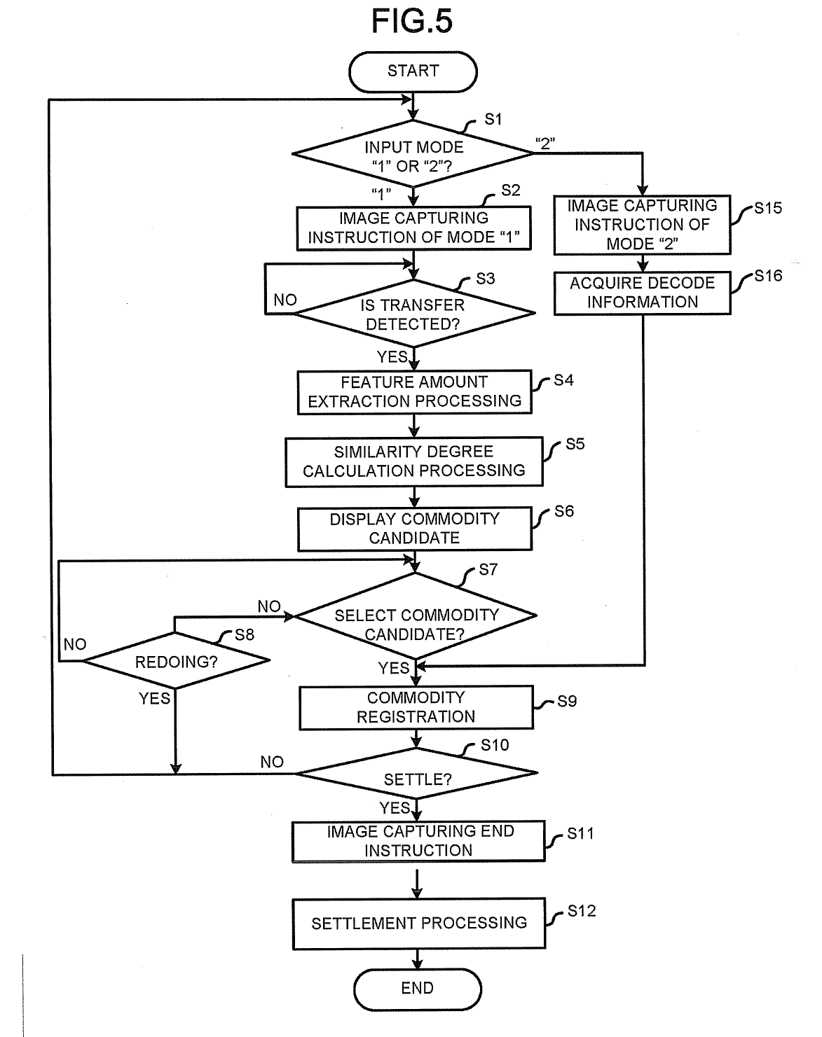

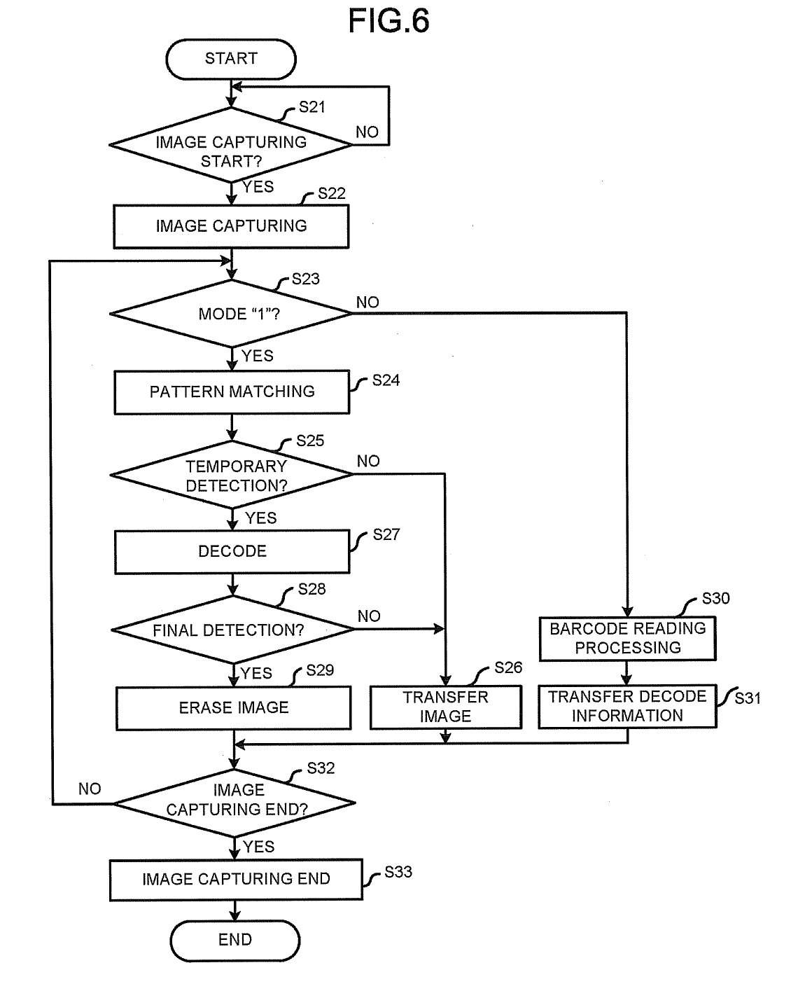

FIG. 5 and FIG. 6 are flowcharts exemplifying a series of operations carried out by the self-checkout POS terminal 1 to read a commodity.

Each processing shown in FIG. 5 is carried out by executing various programs stored in the ROM 32 or HDD 37 by the CPU 31 and controlling each section of the self-checkout POS terminal 1. Further, the processing shown in FIG. 6 carried out by the commodity reading section 23 is carried out through the execution of the programs stored in the ROM 42 by the CPU 41 and the control of each section of the commodity reading section 23.

First, the CPU 31 (the mode input reception section 300) receives the designation of a commodity recognition processing mode (S1). Herein, when a commodity recognition processing is started, the customer presses either of the selection keys of modes displayed on the screen (e.g. a designation key of an object recognition mode (hereinafter referred to as ‘mode 1’ for short) and a designation key of a barcode recognition mode (hereinafter referred to as ‘mode 2’ for short). In this way, the CPU 31 (the mode input reception section 300) receives an instruction on the execution of a commodity recognition processing in the mode (mode 1 or mode 2) corresponding to the selection key pressed by the customer.

If mode 1 is selected in Act S1, the CPU 31 (the image capturing instruction section 301) notifies the commodity reading section 23 of the selection of mode 1 as a commodity recognition processing mode and instructs the commodity reading section 23 to start an image capturing processing (S2). According to the instruction, the commodity reading section 23 acquires a frame image of a commodity by photographing the commodity. Moreover, as the procedure carried out in mode 1, the commodity reading section 23 transfers the acquired frame image from the commodity reading section 23 to the RAM 33.

Further, if mode 2 is selected in Act S1, the CPU 31 (the image capturing instruction section 301) notifies the commodity reading section 23 of the selection of mode 2 as a commodity recognition processing mode and instructs the commodity reading section 23 to start an image capturing processing (S15). According to the instruction, the commodity reading section 23 acquires a frame image of a commodity by photographing the commodity. Moreover, as the procedure carried out in mode 2, the commodity reading section 23 generates decode information from a barcode part included in the frame image and transfers the generated decode information from the commodity reading section 23 to the sales registration section 306.

The series of processing carried out in the commodity reading section 23 will be described in detail later.

In the commodity recognition processing carried out in mode 1, after Act S2 is carried out, the CPU 31 (the frame image detection section 302) detects a notice on the transfer of the frame image from the commodity reading section 23 to the RAM 33 (S3). If the notice is detected in Act S3 (S3: Yes:), the CPU 31 (the object recognition section 303) acquires a given number of frame images from the commodity reading section 23 and copies or decompresses the acquired frame images in the RAM 33. Moreover, a feature amount extraction processing is performed on the optimal frame image (S4). In the processing, a frame image containing a commodity in the center thereof or a frame image containing a clear contour of a commodity is selected from the given number of frame images as the optimal frame image. Moreover, a commodity area included in the selected frame image is specified, and a known feature amount is extracted from the specified commodity area. In this way, the feature amount of the commodity part contained in the frame image is extracted.

Sequentially, the CPU 31 (the commodity candidate presentation section 304) carries out a similarity degree calculation processing according to the feature amount, of the commodity obtained in Act S4 (S5). In the processing, the feature amount of the commodity obtained in Act S4 is compared with the feature amount of each of commodities stored in the dictionary file F2. The similarity degree between the commodity and each commodity stored in the dictionary file F2 is calculated through the comparison.

Then, the CPU 31 (the commodity candidate presentation section 304 and the display control section 308) displays commodity candidates on a display screen (S6). In the processing, based on the similarity degree between the commodity and each of the commodity candidates calculated in Act S5, illustration images of the commodity indicating commodity candidates are aligned in descending order of the similarity degrees to carryout a screen display processing.

Then, the CPU 31 (the input reception section 305) determines whether or not one of the commodity candidates is determined as the commodity (S7). Specifically, the CPU (the input reception section 305) receives, from the plurality of commodity candidates (illustration images of commodities) displayed on the display screen, the input of the illustration image key of a commodity designated by the customer. In this way, the CPU 31 (the input reception section 305) determines that a commodity is determined (S7: Yes). On the other hand, if the CPU 31 (the input reception section 305) does not receive the input of the illustration image key, for example, no illustration image key is designated by the customer, the CPU 31 (the input reception section 305) determines that the commodity is not determined (S7: No).

In a case where the result of the determination of S7 is ‘No’, the CPU 31 (the input reception section 305) determines whether or not there is an instruction on a redoing of the recognition processing (S8). Specifically, if the customer presses a redoing key displayed on the display screen, the CPU 31 (the input reception section 305) receives the input. In this way, the CPU 31 (the input reception section 305) determines that there is a redoing instruction (S8: Yes). In this case, the CPU 31 (the input reception section 305) returns to carry out Act S1. The CPU 31 returns to carry out Act S7 if the result of the determination of Act S8 is ‘No’.

If the result of the determination of Act S7 is ‘Yes’, sequentially, the CPU 31 (the sales registration section 306) carries out a commodity registration processing (S9). In the processing, the CPU 31 (the sales registration section 306) acquires, from the PLU file F1, the commodity data of the commodity determined in Act S7 and registers the commodity data in the sales master file. Further, during the registration, the CPU 31 (the notification section 307) notifies the customer of the sales registration of the commodity by generating a buzzer sound or displaying a notification screen.

Sequentially, the CPU 31 (the input reception section 305) checks the press state of a ‘settlement’ key on the display screen to determine whether or not to settle the registered commodity (S10). The result of the determination of Act S10 is ‘No’ if the ‘settlement ’ key is not pressed by the customer, then the CPU 31 repeats the processing starting with Act S1. That is, an input mode is detected in Act S1, if the detected input mode is still mode 1, then the frame image of a second commodity is acquired in Act S3, and the processing of Acts S3-S9 is carried out for the second commodity. Further, if the mode is changed from mode 1 to mode 2 when the customer presses a mode selection key, the processing relating to barcode recognition starting with Act S15 (the processing carried out in mode 2 described later) is carried out after the determination processing of Act S1 is completed.

The result of the determination of Act S10 is ‘Yes’ if the customer presses the ‘settlement’ key after registering all the commodities in the shopping basket. In this case, the CPU 31 outputs an instruction signal for ending image capturing to the commodity reading section 23 (Act S11). Moreover, the CPU 31 carries out a settlement processing for the commodities registered in the sales master file (S12) and ends the present processing.

The above is operations carried out in mode 1. The operations carried out in mode 2 are as follows:

If mode 2 is selected in Act S1, the CPU 31 (the image capturing instruction section 301) notifies the commodity reading section 23 of the selection of mode 2 as a commodity recognition mode and meanwhile instructs the commodity reading section 23 to start an image capturing processing (S15). Then, the decode information obtained by decoding the barcode part is acquired from the commodity reading section 23 (Act S16). After the processing of Act S16 is ended, the CPU 31 proceeds to carryout the processing of Act S9 to carry out the commodity registration processing. That is, the CPU 31 (the sales registration section 306) acquires, from the PLU file F1, commodity data corresponding to the decode information and registers the commodity data in the sales master file. The flow of processing subsequent to the registration of the commodity data in the sales master file is identical to those described above and is therefore not described here repeatedly.

The operations carried out by the commodity reading section 23 shown in FIG. 6 are described below.

The CPU 41 (the image capturing mode reception section 400) of the commodity reading section 23 first determines whether or not the CPU 31 (the image capturing instruction section 301) gives an image capturing start instruction (S21). In Act S2 or Act S15 shown in FIG. 5, an image capturing start command is output from the CPU 31 (the image capturing instruction section 301) to the commodity reading section 23. The CPU 41 (the image capturing mode reception section 400) of the commodity reading section 23 detects the image capturing start command, thereby determining that the CPU 31 (the image capturing instruction section 301) gives an image capturing start instruction (result of determination: Yes). If the result of the determination is ‘No’, then the determination processing is carried out repeatedly until the result of the determination becomes ‘Yes’.

If the result of the determination of Act S21 is ‘Yes’, the CPU 41 (the image capturing mode reception section 400) turns the image capturing signal of the image capturing section 44 into ‘ON’ to start the image capturing of the image capturing section 44 (Act S22). The customer holds a commodity over the reading window 230 of the commodity reading section 23 to enable the image capturing section 44 to read the appearance image of the commodity. The CPU 41 (the image capturing mode reception section 400) sequentially stores the frame images of the commodity photographed by the image capturing section 44 in the RAM 43.

Then, the CPU 41 (the image capturing mode reception section 400) determines the mode of a commodity recognition processing (S23). Apart from the image capturing start command, mode information of a commodity recognition processing is also output from the CPU 31 (the image capturing instruction section 301) in Act S2 or Act S15 shown in FIG. 5. The CPU 41 (the image capturing mode reception section 400) maintains the mode information in, for example, a register indicating a mode state and reads the mode information to determine that a commodity recognition processing mode is mode 1 or mode 2. It is assumed that the mode state maintained in the register is rewritten every time the mode information of a commodity recognition processing is output from the CPU 31 (the image capturing instruction section 301)

If it is determined in Act S23 that the mode of a commodity recognition processing is mode 1, the CPU 41 checks, whether or not the frame image stored in the RAM 43 is a target on which a commodity recognition processing is to be performed through the following processing.

First, the CPU 41 (the barcode detection section 401) performs a pattern matching processing on the first frame image stored in the RAM 43 (S24). In the pattern matching processing, for example, the pattern matching is carried out for the frame image according to the contour shape of a seal printed with a barcode. Alternatively, the pattern matching is carried out according to contour shapes of bars and spaces consisting of a barcode.

Further, the CPU 41 (the barcode detection section 401) determines whether or not an image conforming to the pattern is contained in the frame image (S25). If the result of the determination is that the image conforming to the pattern is not contained in the frame image (determination: No), the CPU 41 (the frame transfer section 404) notifies the CPU 31 to transfer the frame image from the RAM 43 to the RAM 33 (S26). In this case, the CPU 41 discards the frame image if the CPU 31 carries out an object recognition processing and therefore does not receive a notice. If the CPU 31 receives the notice, the frame image is determined as one of the given number of frame images in Act S4 and assumed as a target on which an object recognition processing is to be executed.

On the other hand, if the CPU 41 (the barcode detection section 401) determines that the image conforming to the pattern is contained in the frame image (determination: Yes), the CPU 41 (the decoding section 402) decodes the frame image (S27). In this processing, the widths of the spaces and bars contained in the frame image are read to decode the barcode into numeral rows. Further, whether or not the decode information such as the numeral rows obtained by decoding corresponds to a code for recognizing the commodity is confirmed. For example, whether or not the values taken by the numerals or the number of digits of the decode information is the value of the code for recognizing the commodity is confirmed through a matching processing.

Further, according to the confirmation processing of Act S27, the CPU 41 (the decoding section 402) determines whether or not the barcode part detected temporarily in Act S25 is a right barcode part (S28). The result of the determination of Act S28 is ‘No’ if it is confirmed in Act S27 that the decode information is not accordant with the code for recognizing the commodity. In this case, the CPU 41 (the frame transfer section 404) notifies the CPU 31 to transfer the frame image from the RAM 43 to the RAM 33 (S26). Further, it is assumed that the frame image in the RAM 43 serving as transfer source is discarded.

On the other hand, the result of the determination of S28 is ‘Yes’ if it is confirmed in Act S27 that the decode information is accordant with the code for recognizing the commodity. In this case, the CPU 41 (the frame erasing section 403) erases the frame image from the RAM 43 as the frame image is not the target on which an object recognition processing is to be performed (S29).

After Acts S26 and S29 are ended, the CPU 41 determines whether or not the CPU 31 (the image capturing instruction section 301) gives an image capturing end instruction (S32). In Act S11 shown in FIG. 5, the CPU 31 notifies the commodity reading section 23 of an image capturing end instruction signal. The CPU 41 of the commodity reading section 23 detects the notification and determines that the CPU 31 sends an image capturing end instruction (determination: Yes). If the result of the determination is ‘Yes’, the CPU 41 turns the image capturing signal of the image capturing section 44 into ‘off’ to end the image capturing processing (S33). On the other hand, if the result of the determination is ‘No’, the processing starting with Act S23 is repeated. That is, processing of Acts S23-S29 is carried out for the next frame image stored in the RAM 43.

Further, if it is determined in Act S23 that the commodity recognition mode is mode 2, the CPU 41 carries out a barcode recognition processing for the frame image stored in the RAM 43 (S30). In the barcode recognition processing, the CPU 41 selects the optimal frame image from a given number of frame images stored in the RAM 43. Then, the CPU 41 (the decoding section 402) generates decode information from the barcode part. Moreover, the CPU 41 (the decode information transfer section 405) notifies the CPU 31 of the transfer of the decode information generated in Act S30 and transfers the decode information to the CPU 31 (the sales registration section 306) (S31). Further, it is assumed that the frame image in the RAM 43 serving as transfer source is discarded.

After Act S31 is ended, whether or not there is an image capturing end instruction is determined in Act S32, and the processing starting with Act S23 is repeated if there is no image capturing end instruction. In the barcode recognition processing, if the decode information is transferred to the CPU 31 (the sales registration section 306), then the commodity corresponding to the decode information is automatically sales-registered. Through the circular execution of Act S23, Act S30, Act S31 and Act S32, the same decode information is generated if a barcode recognition processing is carried out for images of the same commodity. Thus, when the decode information of the same commodity is transferred to the CPU 31 (the sales registration section 306) again, the CPU 31 (the sales registration section 306) detects the repeated transfer and rejects to repeatedly sales-register the commodity.

Further, if the user changes the mode after an image capturing processing is started, the mode information is notified to the commodity reading section 23 in Act S2 or Act S15. The register dedicated to the mode information is updated by the newest mode information, and the newest mode information is read by the CPU 41 during the determination of Act S23. In this way, even if the mode is changed after an image capturing processing is started, the commodity reading section 23 still carries out a recognition processing in the changed mode.

Further, if frame images are continuously erased at the given number in the processing of Act S29 included the foregoing flow of operations, the erasure may be notified through the display of a screen. For example, the number of the continuously erased frame images is counted by the commodity reading section 23, and if the number of the continuously erased frame images is greater than a preset value, the commodity reading section 23 notifies the CPU 31 of this situation. The CPU 31 receives the notice and displays an error screen containing information such as ‘read the side without a barcode please’ on the display device 211. Alternatively, the CPU 41 controls the voice output section 45 to regenerate voice ‘read the side without a barcode please’.

In the foregoing example of the flow of operations, by carrying out the processing of Acts S24, S25, S27, S28 and S29, the commodity reading section 23 detects a frame image including a barcode part and discards the frame image including a barcode. Thus, a frame image including a barcode part will not be transferred to the object recognition processing section. Consequentially, the object recognition processing section carries out a recognition processing only for a frame image containing no barcode part. That is, the reduction in recognition accuracy is prevented. Further, in the pattern matching processing shown in Act S24, a frame image containing no clear barcode part is sieved out so as not to carry out detailed check described above. A suspicious frame image is decoded in Act S27 to be checked in detail. If no barcode part is extracted through a decoding processing, then it is assumed that the part used as a barcode part during the pattern matching processing indicates a part of the features of the commodity, and thus the processing proceeds to object recognition.

(Modification 1)

It is described in embodiment 1 that a frame image including a barcode part is erased by the commodity reading section 23 to exclude the frame image including a barcode part from the targets on which an object recognition processing is to be performed.

In modification 1, frame images and information indicating whether or not there is a barcode part are transferred to the object recognition processing section so that the object recognition processing section selects and processes a frame image containing no barcode part.

The difference between modification 1 and the foregoing embodiment 1 is described below. The elements of modification 1 which are identical to those of embodiment 1 are denoted by the same reference signs and are not described herein repeatedly.

The appearance and the hardware structure of a self-checkout POS terminal of modification 1 are identical to those of the self-checkout POS terminal 1 of embodiment 1 and are therefore not shown and described.

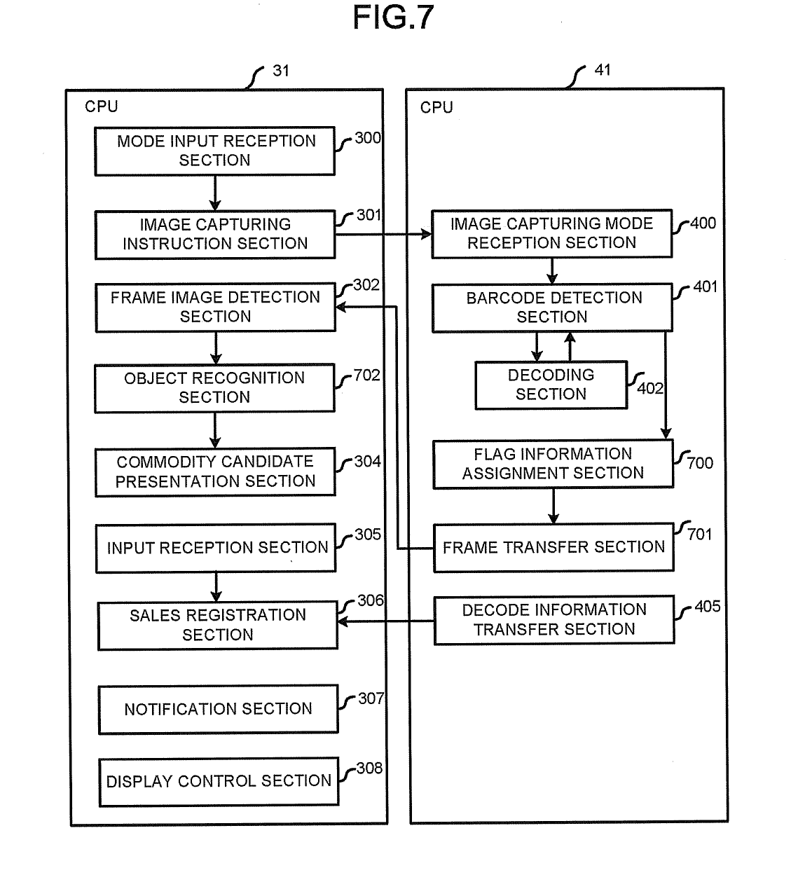

FIG. 7 is a block diagram illustrating the functional structure of a self-checkout POS terminal according to a modification 1. The solid arrow shown in FIG. 7 indicates an instruction direction.

In a self-checkout POS terminal 2 of modification 1 shown in FIG. 7, a flag information assignment section 700 functionally replaces the frame erasing section 403 of the embodiment 1. Further, the under-mentioned frame transfer section 701 functionally replaces the frame transfer section 404, and the under-mentioned object recognition section 702 functionally replaces the object recognition section 303.

The flag information assignment section 700 is the function of the object recognition mode. Flag information (instruction information) which is information associated with each frame image is set by fault to be “0” indicating the absence of a barcode part. If it is finally determined by the barcode detection section 401 that a barcode part is included in a frame image, the flag information assignment section 700 rewrites the flag information of the frame image from “0” to “1”.

The frame transfer section 701 notifies the CPU 31 of the transfer of the frame image, sets the frame image and the flag information and transfers all the frame images from the RAM 43 to the RAM 33.

The frame image detection section 302 detects the transfer of the frame images of a commodity from the commodity reading section 23 and the storage of the frame images in the RAM 33 after an image capturing processing of the frame images is started.

The object recognition section 702 performs an object recognition processing (pre-processing) on a frame image which is detected by the frame image detection section 302 and the flag information of which is “0”. For example, the object recognition processing (pre-processing) is a processing of specifying a commodity image area in a frame image and extracting the appearance information such as the tint, the pattern and the concave-convex state of surface of the commodity shown in the area as a feature amount.

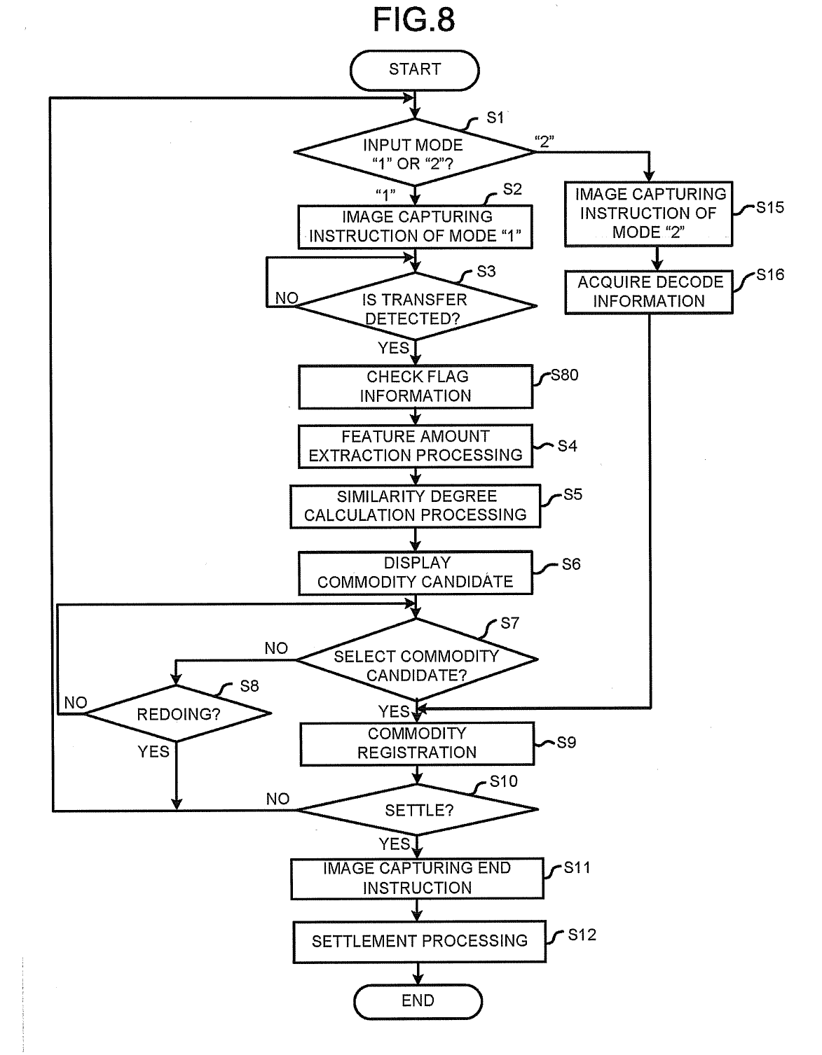

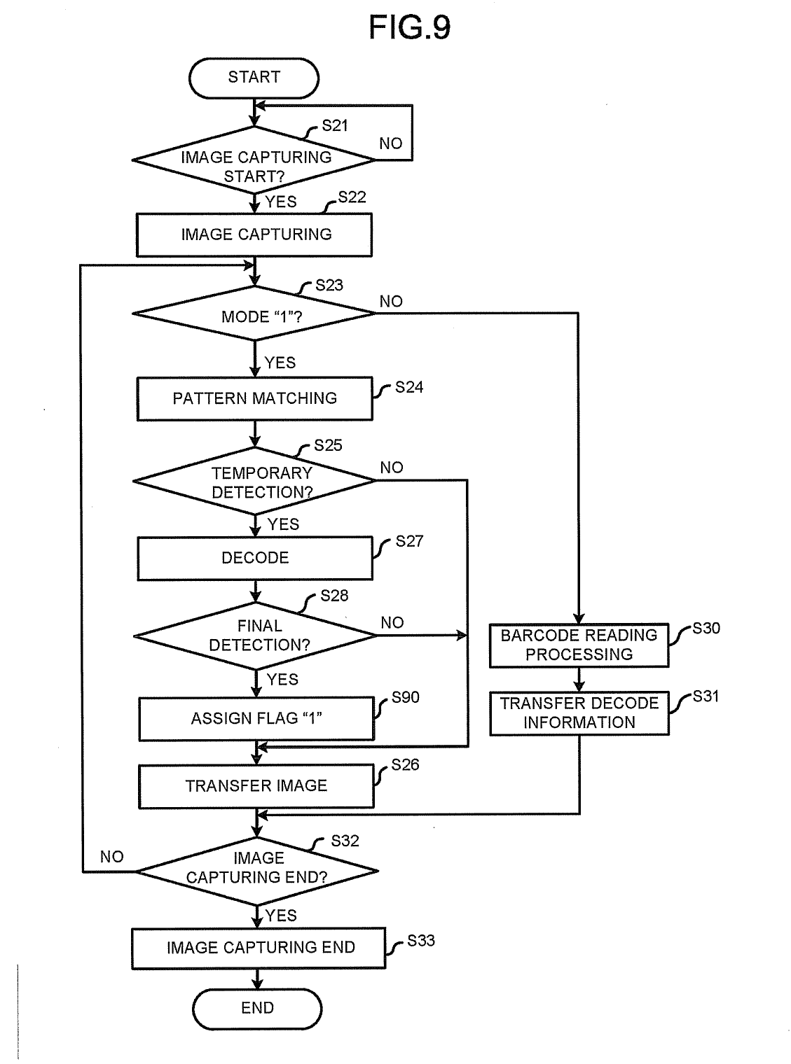

FIG. 8 and FIG. 9 are flowcharts exemplifying a series of operations carried out by the self-checkout POS terminal 2 to read a commodity.

The flow shown in FIG. 8 includes an additional S80 when compared with the flow shown in FIG. 5.

In the commodity recognition processing carried out in mode 1, after Act S2 is ended, the CPU 31 (the frame image detection section 302) detects a notice on the transfer of frame images from the commodity reading section 23 to the RAM 33 (S3). If the CPU 31 (the frame image detection section 302) detects the notice (S3: Yes), the CPU 31 (the object recognition section 702) acquires a given number of frame images from the commodity reading section 23 and copies or decompresses the acquired frame images in the RAM 33. Moreover, the flag information of each frame image is investigated to check whether or not the frame image is the target on which an object recognition processing is to be performed (S80). The frame image the flag information of which is “0” is determined as a frame image on which an object recognition processing is to be performed. The frame image the flag information of which is “1” is determined as a frame image on which no object recognition processing is to be performed and is therefore erased.

Sequentially, the CPU 31 (the object recognition section 702) carries out a feature amount extraction processing on the optimal one of the frame images the flag information of which is “0” (S4).

The following processing starting with Act 4 is the object recognition processing described in the embodiment 1 and therefore is not described in detail herein.

In the flow shown in FIG. 9, an additional Act S90 replaces Act S29 included in the flow shown in FIG. 6.

As described in the embodiment 1, in Act S28, the CPU 41 (the decoding section 402) determines whether or not the inclusion of a barcode part in the frame image is finally determined. It is assumed herein that the result of the determination is ‘Yes’ as a barcode part is included in the frame image. Therefore, the CPU 41 (the flag information assignment section 700) rewrites the flag information corresponding to the frame image from “0” to “1” (S90).

Then, the CPU 41 (the frame transfer section 701) notifies the CPU 31 of the transfer of the frame image and the flag information and transfers the frame image and the flag information ‘1’ from the RAM 43 to the RAM 33 (S26).

Further, if the result of the determination of Act S25 or S28 is ‘No’, the CPU 41 (frame transfer section 701) transfers the frame image and the flag information ‘0’ from the RAM 43 to the RAM 33 in Act S26. Moreover, it is assumed that the frame image and the flag information in the RAM 43 serving as transfer source are discarded.

Thus, the CPU 41 of the commodity reading section 23 sends each frame image to the object recognition processing section, regardless of whether or not the frame image includes a barcode part. The object recognition processing section checks the flag information of each frame image so as to carry out an object recognition processing for a frame image including no barcode part.

Further, if there is a given number of successive frame images the flag information of which is “1”, then this situation may be notified through the display of a screen in the processing of Act S80 included in the foregoing flow of operations. For example, the successive number of the frame images the flag information of which is 1 is counted, and if the counted successive number is above a preset value, the CPU 31 displays an error screen containing information such as ‘read the side without a barcode please’ on the display device 211.

Further, if there is a given number of successive frame images the flag information of which is “1”, the CPU 41 of the commodity reading section 23 counts the successive number of the frame images the flag information of which is 1 in the processing Act S90, and if the counted successive number is above a preset value, the CPU 41 of the commodity reading section 23 controls the voice output section 45 to regenerate voice ‘read the side without a barcode please’.

In the foregoing example of the flow of operations, by carrying out Acts S24, S25, S27, S28, S80 and S90, the CPU 31 detects a frame image including a barcode part so that a frame image including a barcode part is not processed by the object recognition processing section. Consequentially, the object recognition processing section carries out a recognition processing only for, a frame image including no barcode part. That is, the reduction in recognition accuracy is prevented.

A self-checkout POS terminal is described as a commodity sales data processing apparatus in the present embodiment and the modification thereof. However, not limited to a self-checkout POS terminal, the commodity sales data processing apparatus may be another apparatus. For example, the commodity sales data processing apparatus may be a checkout system operated by a shop clerk. In the case of the checkout system, for example, the commodity reading section 23, the display device 211, the touch panel 210 and the connection interface 47 shown in FIG. 3 are separately arranged as a commodity reading apparatus, and an apparatus consisting of the other structures added with an input section such as a keyboard is arranged as a POS register.

In the present embodiment and the modification thereof, a commodity sales data processing apparatus comprises a sales registration section and a settlement processing section. However, it is also applicable that the settlement processing section is separately arranged as a settlement terminal and the commodity sales data processing apparatus only comprises a sales registration section.

The various programs used by the commodity sales data processing apparatus of the present embodiment and the modification thereof may be recorded in a computer-readable recording medium such as a CD-ROM, a Flexible Disk (FD), a CD-R, and a DVD (Digital Versatile Disk) in the form of installable and executable file to be provided and read into a flash ROM of the commodity sales data processing apparatus to be executed.

Further, the programs may be stored in a computer connected with a network such as an Internet and downloaded via the network.

Structures of a commodity sales data processing apparatus, a reading apparatus and a method by the same are described in the foregoing embodiment and a modification thereof, however, the foregoing embodiment and the modification thereof have been presented by way of example only, and are not intended to limit the scope of the present invention. Indeed, the novel embodiments and modification may be embodied in a variety of other forms; furthermore, various omissions, substitutions and variations thereof may be devised without departing from the spirit of the present invention. The accompanying claims and their equivalents are intended to cover such forms and modifications as would fall within the scope and spirit of the present invention.

What is claimed is:

1. A commodity sales data processing apparatus, comprising:
an image capturing module configured to photograph a commodity and output the appearance image of the commodity;
an extraction module configured to extract barcode information from the appearance image of the commodity output from the image capturing module;
an object recognition module configured to perform an object recognition processing on the appearance image of the commodity output through the image capturing module;
an exclusion module configured to exclude, if barcode information is extracted from the appearance image of the commodity by the extraction module, the appearance image of the commodity, from the targets on which the object recognition processing is to be performed by the object recognition module;
a determination module configured to determine the commodity to be sales-registered according to the result of the object recognition processing; and
a sales registration module configured to carry out a sales registration of the commodity determined by the determination module.

2. The commodity sales data processing apparatus according to claim 1, wherein
by not inputting the appearance image of the commodity output from the image capturing module into the object recognition module, the exclusion module excludes the appearance image of the commodity from the targets on which the object recognition processing is to be performed by the object recognition module.

3. The commodity sales data processing apparatus according to claim 1, wherein
by assigning instruction information for instructing the object recognition module not to carry out the object recognition processing in the appearance image of the commodity output from the image capturing module and inputting the instruction information to the object recognition module, the exclusion module excludes the appearance image of the commodity from the targets on which the object recognition processing is to be performed by the object recognition module.

4. The commodity sales data processing apparatus according to claim 1, wherein
the extraction module temporarily extracts the barcode information through a pattern recognition processing, and if the barcode information is temporarily extracted, the barcode information is finally extracted through a decoding operation.

5. A reading apparatus, comprising:
an image capturing module configured to photograph a commodity and output the appearance image of the commodity;
an extraction module configured to extract barcode information from the appearance image of the commodity output from the image capturing module;
a transfer module configured to transfer the appearance image of the commodity output from the image capturing module to an object recognition processing device; and
an exclusion module configured to, if barcode information is extracted from the appearance image of the commodity by the extraction module, prevent the transfer of the appearance image of the commodity output from the image capturing module to the object recognition processing device or assign instruction information for instructing the object recognition processing device not to carry out the object recognition processing in the appearance image of the commodity output from the image capturing module.

6. A method for enabling a computer equipped with an image capturing section for photographing a commodity to function as the following modules, including:
extracting barcode information from the appearance image of the commodity output from the image capturing section;
performing an object recognition processing on the appearance image of the commodity output from the image capturing section; and
excluding, if barcode information is extracted from the appearance image of the commodity, the appearance image of the commodity from the targets on which the object recognition processing is to be performed.
